(19) United States
(12) Patent Application Publication
(10) Pub. No.: US 2005/0028550 A1
(43) Pub. Date: Feb. 10, 2005

(54) Cooler for water or other beverage

(76) Inventor: Marcel E. Crettet IV, San Antonio, TX (US)

Correspondence Address: John R. Casperson, PO Box 2174, Friendswood, TX, 77549, US

(21) Appl. No.: 10/775,783

(22) Filed: Feb. 10, 2004

Related U.S. Application Data
(60) Provisional application No. 60/492,928, filed on Aug. 6, 2003.

(51) Int. Cl. B67D 5/62

(52) U.S. Cl. 62/391; 62/397; 222/146.1

(57) ABSTRACT

Improvements to an apparatus for cooling and dispensing water or other beverages are: providing the apparatus with a collapsible bag to facilitate sanitizing the device, providing the apparatus with a chiller configured to prevent thermal stratification and freezeups of the liquid therein, providing the apparatus with a container positioned in a lower portion thereof prevent liquid leakage beneath the unit, providing the apparatus with adaptability for resupply by either bottle or building water supply, and providing the apparatus with a modular structure which can be largely disassembled without tools to facilitate cleaning, maintenance and repair.

### CROSS REFERENCES TO RELATED APPLICATIONS

This application claims the benefit of U.S. Provisional Application No. 60/492,928 filed Aug. 6, 2003, the disclosure of which is herein incorporated by reference.

### BACKGROUND OF THE INVENTION

This invention relates generally to a cooler for water or other beverages.

Water coolers for bottled water are well known. Typically, a multi-gallon bottle of water is positioned upside-down over a reservoir to gravity feed into the reservoir and maintain an operating water level. Water is withdrawn from the reservoir via one or more dispensers into a container for consumption by users. In some units, a refrigeration unit chills the water.

One of the deficiencies of commercial coolers is that the reservoir is difficult to clean. A water cooler having an easy-to-clean reservoir would be very desirable. Such a cooler could be used for beverages other than water, for example, where contamination by microorganisms would rapidly become a problem if the reservoir were not regularly cleaned.

Another deficiency of commercial coolers is that the water in the reservoir tends to stratify as it is cooled. This can lead to ice formation in the reservoir, which reduces performance of the unit. A water cooler which provides sufficient circulation in the reservoir to prevent stratification and ice formation would be very desirable.

A further deficiency of commercial coolers is leakage. Leakage results from several factors, but one of the most common is condensation on the cold surfaces, which is especially a problem in humid areas, or where the cooler is exposed to outside air. Leakage can result in odor problems and property damage, such as ruined floors and carpeting, and can also create a risk of slip and fall with resultant personal injury. A water cooler which provides for better control of leakage would be very desirable.

Another deficiency of commercial coolers is that they are difficult to maintain and service. A cooler which has a modular design so that it is easy to maintain and service would be very desirable.

A further deficiency of commercial coolers is that they are not easily converted away from a bottled water supply. A cooler which can be easily converted for operation with a modular water filtering system would be very desirable.

It is an object of this invention to provide a cooler for water and other beverages which overcomes the above-noted deficiencies.

### SUMMARY OF THE INVENTION

In one embodiment of the invention, an apparatus for cooling and dispensing water or other beverage is provided with a chiller configured to prevent thermal stratification and freezeups of the liquid therein. The apparatus comprises a reservoir means for holding a liquid, a refrigeration means for cooling the liquid in the reservoir means, and a dispenser means for dispensing liquid from the reservoir means. The reservoir means has an upper portion and a lower portion and the refrigeration means includes a chiller operatively associated with the lower portion of the reservoir means. The dispenser means includes a flow path means for defining a liquid flow path from the lower portion of the reservoir means to an outside of the apparatus. The chiller is configured to non-uniformly remove heat from the liquid in the reservoir means, thereby causing convection currents which prevent thermal stratification of the liquid in the reservoir means.

In another embodiment of the invention, an apparatus for cooling and dispensing water or other beverages is provided with a collapsible bag to facilitate sanitizing the device. The apparatus comprises a reservoir means for holding a liquid, a refrigeration means for cooling the liquid in the reservoir means, and a dispenser means for dispensing liquid from the reservoir means. The reservoir means has an upper portion and a lower portion and the refrigeration means includes a chiller operatively associated with the lower portion of the reservoir means. The dispenser means includes a flow path means for defining a liquid flow path from the lower portion of the reservoir means to an outside of the apparatus. The reservoir means includes a collapsible bag for containing the liquid, and a sidewall supporting the collapsible bag.

In another embodiment of the invention, an apparatus for cooling and dispensing water or other beverages is provided with a container positioned in a lower portion thereof to prevent liquid leakage beneath the unit. The apparatus comprises a reservoir means for holding a liquid, a refrigeration means for cooling the liquid in the reservoir means, and a dispenser means for dispensing liquid from the reservoir means. The reservoir means has an upper portion and a lower portion and the refrigeration means includes a chiller operatively associated with the lower portion of the reservoir means. The dispenser means includes a flow path means for defining a liquid flow path from the lower portion of the reservoir means to an outside of the apparatus. The apparatus further comprises a housing supporting the chiller, and a container for liquids positioned in the housing for receiving downwardly falling droplets of condensate and leakage.

In a further embodiment of the invention, an apparatus for cooling and dispensing water and other beverages is adapted for resupply by either bottle or building water supply. The apparatus comprises a reservoir means for holding a liquid, a refrigeration means for cooling the liquid in the reservoir means, and a dispenser means for dispensing liquid from the reservoir means. The reservoir means has an upper portion and a lower portion and the refrigeration means includes a chiller operatively associated with the lower portion of the reservoir means. The dispenser means includes a flow path means for defining a liquid flow path from the lower portion of the reservoir means to an outside of the apparatus. The reservoir means further includes a collapsible bag for containing the liquid, and a sidewall supporting the collapsible bag. The apparatus further comprises a lid positioned on the upper end of the sidewall supporting the collapsible bag. The lid can take a variety of forms, to accommodate different bottle sizes, for example, or can be provided with a modular structure to accept a variety of means for refilling the reservoir. For example, the apparatus would be highly suitable for dispensing drink mixes, where daily cleaning or cleaning between different fills would be important.

### BRIEF DESCRIPTION OF THE DRAWINGS

FIG. 1 is a pictorial representation of one embodiment of the present invention.

FIG. 2 is a view of the back side of the device shown in FIG. 1.

FIG. 3 is a view of the device shown in FIG. 1 with a cover removed to show construction details.

FIG. 4 is an exploded view of a portion of the device shown in FIG. 3 showing additional construction details.

FIG. 5 is an exploded view of a portion of the device shown in FIG. 4 showing additional construction details.

FIG. 6 is another exploded view of a portion of the device shown in FIG. 4 showing additional construction details.

FIG. 7 is a back side view of a portion of the device shown in FIG. 5 showing additional details.

FIG. 8 is a view of a portion of the device shown in FIG. 1, with a filtration device positioned on top instead of the water bottle, with portions of the housing broken away to show design details.

FIG. 9 is a schematic view of an embodiment of the invention, illustrating controls and other details not shown in the other Figures.

FIG. 10 is an exploded pictorial view of another embodiment of the invention.

FIG. 11 is an exploded view of a portion of the device shown in FIG. 10.

FIG. 12 is a schematic view of an embodiment of the invention, illustrating controls and other details for the embodiments shown in FIGS. 10 and 11 and not shown in the other Figures.

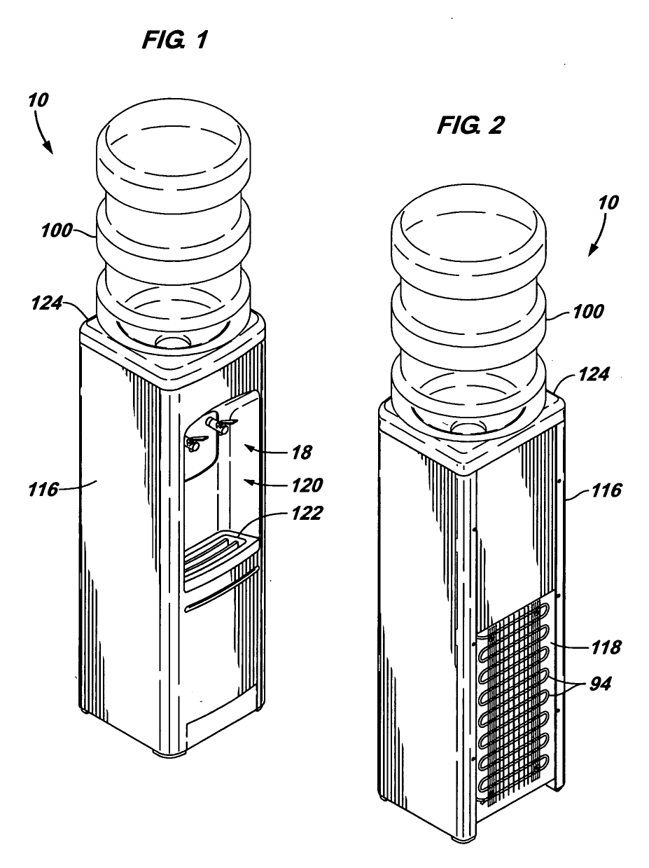

### DETAILED DESCRIPTION OF THE INVENTION

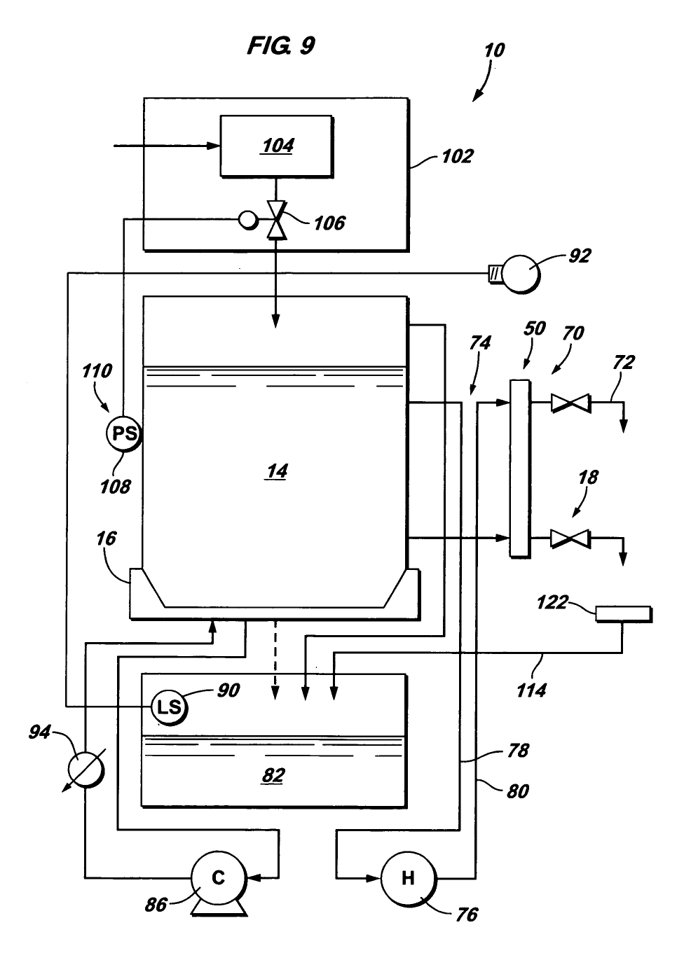

In one embodiment of the invention, an apparatus 10 for cooling and dispensing water or other beverages is provided with a chiller configured to prevent thermal stratification and freezeups of the liquid therein. The apparatus comprises a reservoir means 14 for holding a liquid, a refrigeration means 16 for cooling the liquid in the reservoir means, and a dispenser means 18 for dispensing liquid from the reservoir means. See FIGS. 3 and 9. The reservoir means has an upper portion 20 and a lower portion 22 and the refrigeration means includes a chiller 12 operatively associated with the lower portion of the reservoir means. The dispenser means includes a flow path 24 means for defining a liquid flow path from the lower portion of the reservoir means to an outside of the apparatus. The chiller is configured to non-uniformly remove heat from the liquid in the reservoir means, thereby causing convection currents which prevent thermal stratification of the liquid in the reservoir means. The chiller preferably has a chiller surface facing the liquid in the reservoir means, at least a portion of which is sloped with respect to vertical. Further details of a preferred embodiment are described elsewhere herein.

In another embodiment of the invention, the apparatus 10 is provided with a collapsible bag 26 to facilitate sanitizing the device. The apparatus comprises a reservoir means 14 for holding a liquid, a refrigeration means 16 for cooling the liquid in the reservoir means, and a dispenser means 18 for dispensing liquid from the reservoir means. The reservoir means has an upper portion and a lower portion and the refrigeration means includes a chiller 12 operatively associated with the lower portion of the reservoir means. The dispenser means includes a flow path means 24 for defining a liquid flow path from the lower portion of the reservoir means to an outside of the apparatus. The reservoir means includes a collapsible bag 26 for containing the liquid, and a sidewall 28 supporting the collapsible bag.

Preferably, the sidewall supporting the collapsible bag is thermally insulated or is constructed of a thermally insulating material, most preferably a thermally insulating material other than Styrofoam. Preferably, the reservoir is insulated to at least an R-12 value. It is also preferred that the sidewall supporting the collapsible bag be of one-piece construction, for example, tubular or a panel which snaps itself into a tubular configuration. However, multiple-piece construction can also be used with good results.

For good heat transfer, and to eliminate or mitigate thermal stratification in the reservoir, it is preferred that chiller have a chiller surface which supports a lower portion of the collapsible bag and that at least a portion of the chiller surface is sloped with respect to vertical. Chilled water in a still environment has a tendency to stratify and can sometimes freeze. Providing the chiller with a sloping surface sets up currents to prevent this. Ice which may form adjacent the chiller surface is swept away by the currents and is melted.

A preferred form of chiller has an opposed pair of chiller surface portions 30, 32 which are sloped with respect to vertical and the chiller surface forms a U-bend in cross section. Three-dimensionally, the chiller surface which supports the lower portion of the bag is preferably generally trough-shaped.

To prevent condensate formation, the chiller preferably has an insulated chiller surface 34 opposite from the chiller surface supporting the bag. The insulated chiller surface is preferably is generally flat.

In one aspect of the invention, an outer wall of the chiller is received in a lower portion of the sidewall supporting the insulated bag. Where the sidewall is adequately insulated, it prevents condensate formation at this location.

The flow path means preferably includes a fixture 40 carried by the sidewall of the collapsible bag. In one embodiment, the fixture includes a flexible nozzle-plate 42 of greater rigidity than the sidewall on which it is carried. The nozzle-plate having an outwardly facing surface and at least one outwardly-directed nozzle 44 carried on the outwardly facing surface. The nozzle-plate and nozzle define a flow path for liquid through the sidewall of the collapsible bag. The bag and fixture can be separately fabricated by known means.

The flow path means preferably further includes a valve assembly unit 50 attached to the nozzle and operable to selectively stop and start flow of liquid through the flow path. A variety of mechanisms are suitable. The illustrated valve assembly unit comprises a valve-plate 52 having a front side and a back side and a faucet 54 protruding from the front side. The faucet and valve plate define a flow path for liquid through the valve assembly unit from a liquid inlet on the back side of the valve-plate to an outlet at an outlet end of the faucet. The nozzle carried by nozzle-plate sealingly engages the liquid inlet on the back side of the valve-plate to complete the flow path.

In the interest of modular construction and to facilitate bag replacement, the outwardly facing surface of the nozzle-plate further preferably defines a plurality of latch elements 60 and the back side of the valve plate carries a matching plurality of latch elements which engage with the plurality of latch elements on the nozzle-plate so that the valve-plate is latched to the nozzle-plate. A hook and slot arrangement which engages with lateral (vertical) movement is suitable.

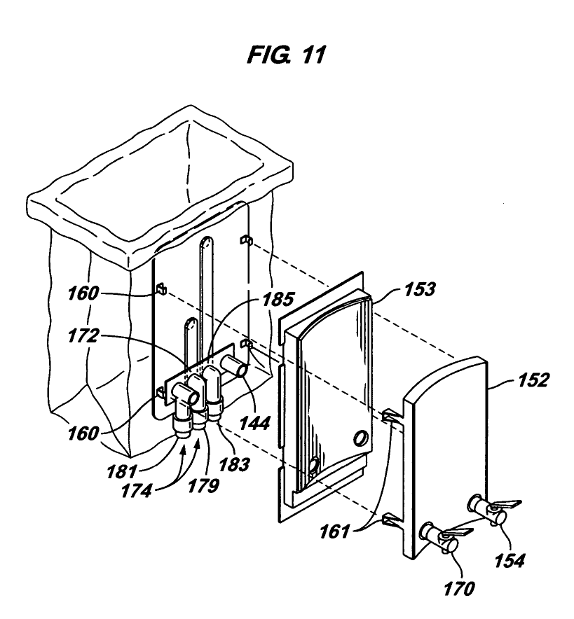

In the embodiment of the invention shown in FIG. 11, the valve assembly unit comprises a valve-plate 152 having a front side and a back side and a faucet 154 protruding from the front side. The faucet and valve plate define a flow path for liquid through the valve assembly unit from the liquid inlet on the back side of the valve-plate to the outlet end of the faucet. The nozzle 144 carried by nozzle-plate sealingly engages the liquid inlet on the back side of the valve-plate. An insulating plate 153 is positioned between the valve plate and the nozzle plate. The nozzle-plate further defines a plurality of latch elements 160 and the back side of the valve plate carries a matching plurality of latch elements 161 which the plurality of latch elements on the nozzle-plate so that the valve-plate is latched to the nozzle-plate with the insulating plate being sandwiched between the valve plate and the nozzle plate. Preferably the latches engage with a straight-in pushing motion and provide positive location.

As additional simplification, the sidewall supporting the collapsible bag is provided with a notch in the front side extending from the upper end for receiving the valve-plate, so that the nozzle-plate can be latched to the valve-plate to form an assembly which can be slid into location in the notch. Most preferably, the nozzle-plate and the valve-plate would be injection molded as a unit. A tenon and mortise construction is suitable.

The collapsible bag is preferably formed from a thermoplastic film. It preferably has a front side wall, a back side wall, a bottom wall, and a pair of pleated side walls. The sidewall which carries the fixture through which liquid is withdrawn from the bag is the front side wall, and the bottom wall of the collapsible bag rests on the chiller. For ease in transportation, such as by mail, the bag having this construction will collapse to an essentially flat configuration.

If desired, the apparatus can be provided a second dispenser 70 (see FIG. 9). In the illustrated embodiment for accomplishing this result, the nozzle-plate has a second outwardly-directed nozzle 72 carried on the outwardly facing surface to define a second flow path for liquid through the sidewall of the collapsible bag. The valve-plate has a second faucet protruding from the front side and a flow path is defined through the valve assembly unit from a second liquid inlet on the back side of the valve-plate to an outlet at an outlet end of the second faucet. Means 74 is provided for defining a liquid flow path between the second outwardly-directed nozzle and the second liquid inlet on the back side of the valve-plate, which, in the illustrated embodiment (see FIG. 9), includes a heater 76, a first conduit 78 extending between the second outwardly directed nozzle and the heater, and a second conduit 80 extending between the heater and the second liquid inlet. In this manner, heated liquid can be dispensed from the second faucet.

Preferably, the heater is positioned in the housing beneath the chiller, so that the chiller is insulated therefrom.

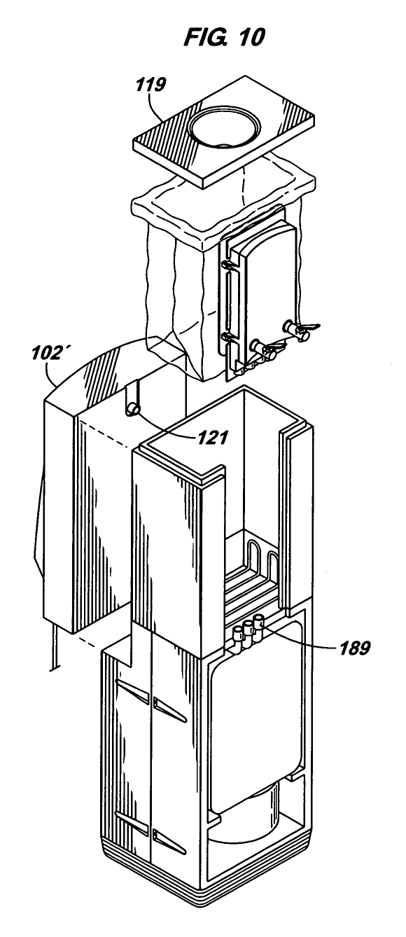

In the embodiment of the invention illustrated in FIG. 11, the second dispenser 170 is connected by conduit means in a manner similar to that shown in FIG. 9 to the outwardly directed nozzle 172 on the nozzle plate. A means 174 is provided for defining a liquid flow path between the second outwardly-directed nozzle and the second liquid inlet on the back side of the valve-plate, which, in the illustrated embodiment includes a first quick-connect coupler element 179 to connect the nozzle outlet to the conduit leading to the heater and a second quick-connect coupler element 181 which connects the conduit leading back from the heater to the dispenser. Another quick-connect coupler 183 preferably connects the overflow nozzle 185 to the conduit leading to the overflow receptacle. The couplers 179, 181, and 183 preferably form an upper half 187 of a manifold arrangement which quick connects with a stabbing motion with the matching lower half 189 as shown in FIG. 10. The arrangement permits the flow paths quickly connected or disconnected which greatly facilitates servicing the unit. The upper halves of the couplers are preferably provided with check valves to prevent leakage when the bag assembly is removed for service. By quick-connect is meant a connector which can be sealed fluid tight with only longitudinal motion and without tools.

In another embodiment of the invention, an apparatus 10 for cooling and dispensing water or other beverages is provided with a container 82 positioned in a lower portion thereof to prevent liquid leakage beneath the unit. The apparatus comprises a reservoir means 14 for holding a liquid, a refrigeration means 16 for cooling the liquid in the reservoir means, and a dispenser means 18 for dispensing liquid from the reservoir means. The reservoir means has an upper portion and a lower portion and the refrigeration means includes a chiller operatively associated with the lower portion of the reservoir means. The dispenser means includes a flow path means for defining a liquid flow path from the lower portion of the reservoir means to an outside of the apparatus. The apparatus further comprises a housing 84 supporting the chiller, and the container 82 is positioned in the housing for receiving downwardly falling droplets of condensate and leakage.

Preferably, the refrigeration means further comprises a compressor 86 positioned in the housing beneath the container. A refrigeration means employing solid state heat transfer would also be suitable, and would be silent, as well.

In the interest of preventing overflows, the apparatus preferably further comprises a means 88 for indicating when a liquid level in the container has exceeded a predetermined limit. See FIG. 9. The indicating means can comprise a sensor 90 operatively associated with an inside of the container for sensing when a liquid level in the container has exceeded a predetermined limit and producing an output signal in response thereto and an alarm device 92 operatively associated with the sensor for producing an alarm signal in response to the output signal from the sensor. Suitable alarm signals are lights or buzers, for example. A wide range of sensors may be used to determine whether the liquid level has exceeded the predetermined limit.

To facilitate emptying, the container is preferably sidably received in the housing. See FIG. 3. In the illustrated embodiment, the housing has a front side and a back side and the container is slidably received in an opening in the front side of the housing. The refrigeration means preferably further comprises a condenser coil 94 positioned on a back side of the housing. The condenser coil is preferably generally panel-shaped and the back side of the housing further preferably defines a generally panel-shaped recess for receiving the condenser coil and the condenser coil is positioned in the recess.

In a further embodiment of the invention, an apparatus 10 for cooling and dispensing water and other beverages is adapted for resupply by either bottle or building water supply. The apparatus comprises a reservoir means 14 for holding a liquid, a refrigeration means 16 for cooling the liquid in the reservoir means, and a dispenser means 18 for dispensing liquid from the reservoir means. The reservoir means has an upper portion and a lower portion and the refrigeration means includes a chiller operatively associated with the lower portion of the reservoir means. The dispenser means includes a flow path means for defining a liquid flow path from the lower portion of the reservoir means to an outside of the apparatus. The reservoir means further includes a collapsible bag 26 for containing the liquid, and a sidewall 28 supporting the collapsible bag. The apparatus further comprises a lid 96 positioned on the upper end of the sidewall supporting the collapsible bag. The lid is preferably insulated and can take a variety of forms, to accommodate different bottle sizes, for example, or can be provided with a modular structure to accept a variety of means for refilling the reservoir. For example, the apparatus would be highly suitable for dispensing drink mixes, where daily cleaning or cleaning between different fills would be important.

In the illustrated embodiment, (See FIG. 3) the lid has a central opening and the collapsible bag for containing the liquid has an open upper end which is rolled over an upper end of the sidewall supporting the collapsible bag. The lid sandwiches the upper end of the collapsible bag between the upper end of the sidewall and the lid. The arrangenent securely fixes the bag yet permits easy removal and reinstallation.

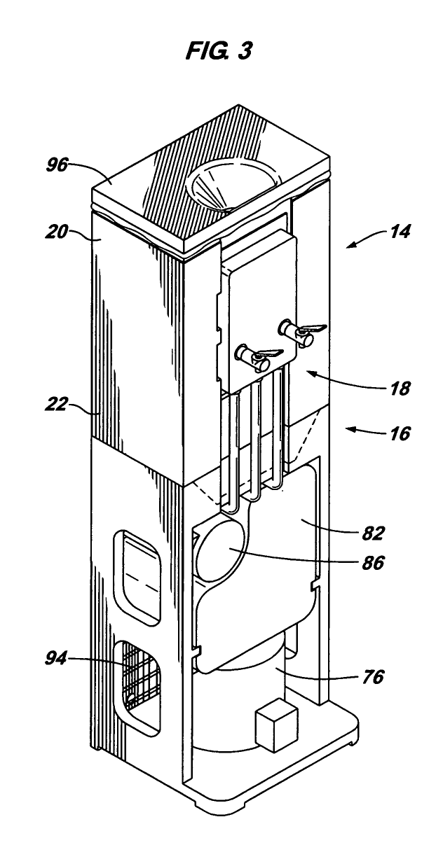

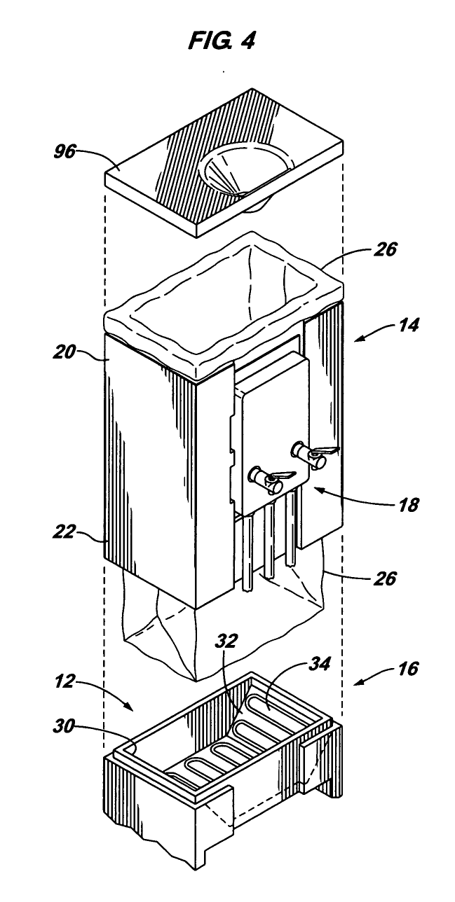

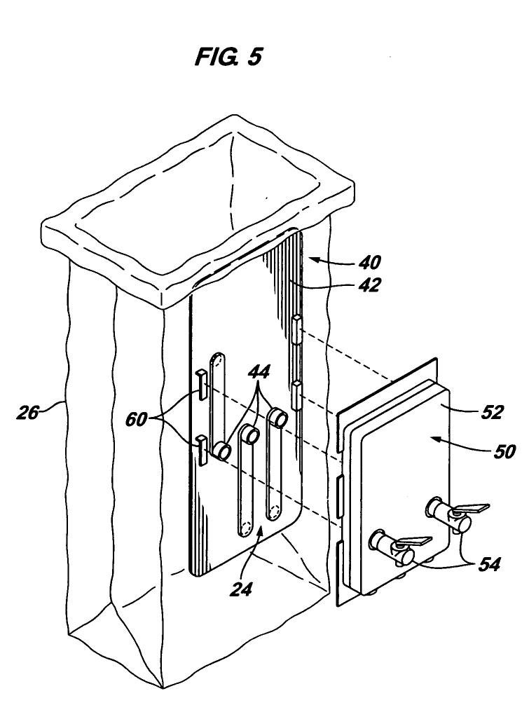

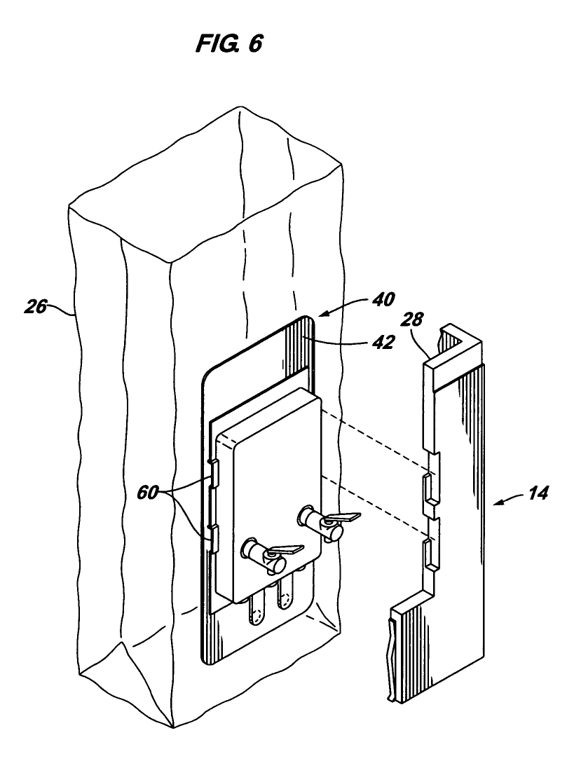

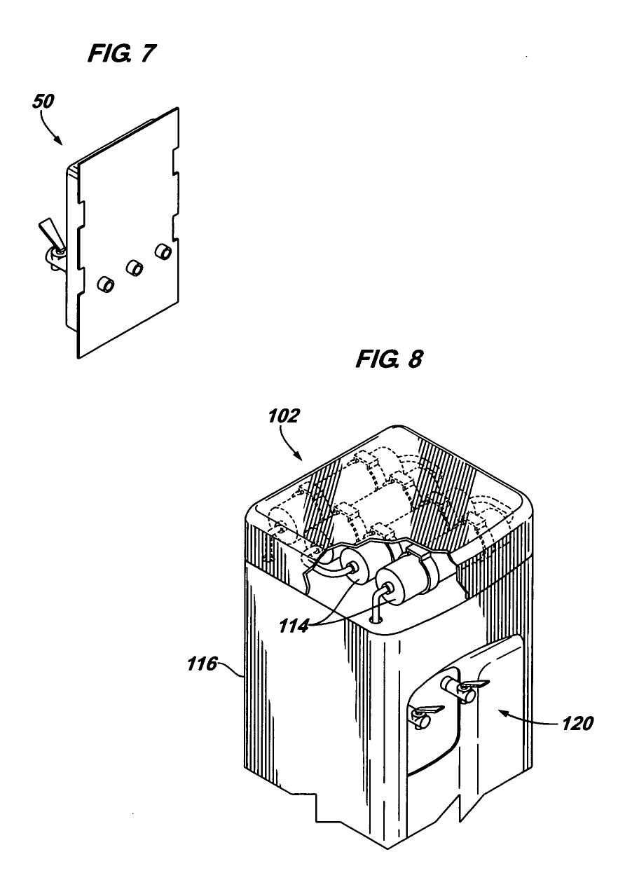

In a first illustrated set-up, the apparatus is provided with a water bottle 100 positioned upside down partially through the central opening of the lid to supply water to the inside of the collapsible bag. The nozzle of the bottle is positioned through the opening to the inside of the bag and the bag is resupplied from the bottle by gravity when the liquid level falls beneath the water bottle outlet. See FIG. 2.

In a second illustrated set up, a filtration module 102 is positioned in covering relationship with the lid. See FIGS. 8 and 9. The filtration module has an inlet for receipt of water from a building water system, at least one filter 104 to filter the received water, and an outlet to supply filtered water through the central opening of the lid to the inside of the collapsible bag. An inlet valve 106 is provided to control flow of water through the filtration module. The apparatus is provided with means 108 for sensing when the liquid level in the collapsible bag has fallen to a predetermined lower limit and producing an output signal in response thereto to open the inlet valve and cause flow of water through the filtration module and into the collapsible bag, and sensing when the liquid level in the collapsible bag has risen to a predetermined upper limit and terminating the output signal to close the inlet valve and stop the flow of water into the collapsible bag.

Preferably, the means for sensing comprises a pressure switch 110 positioned between the outside of the collapsible bag and the sidewall supporting the collapsible bag near a lower portion of the collapsible bag. The pressure switch is selected to transmit an electrical signal to actuate the valve 106 when sensed pressure fills to a predetermined lower limit and ceasing to transmit the electrical signal when sensed pressure reaches a predetermined upper limit.

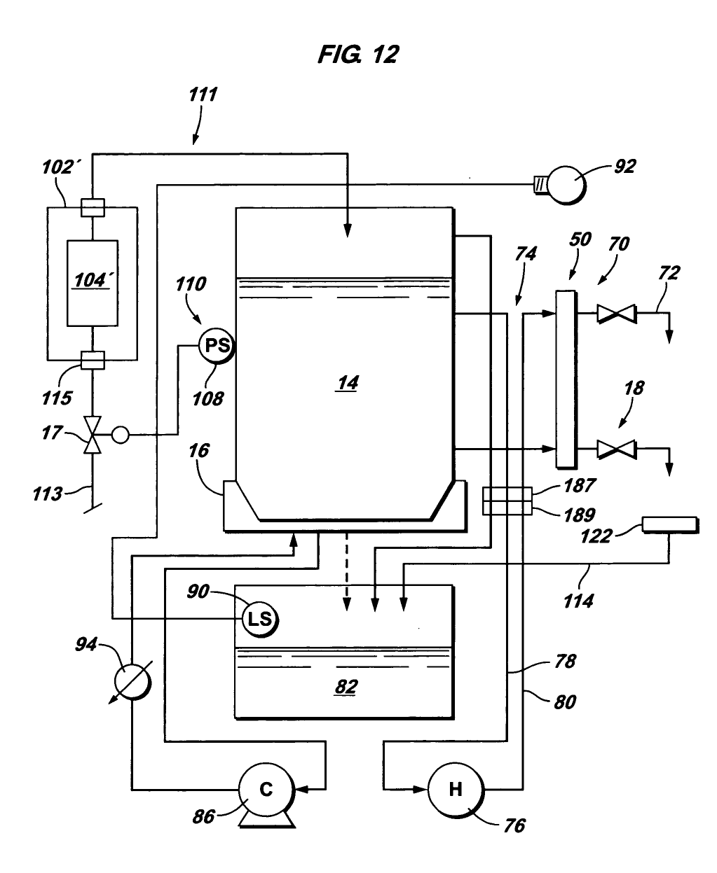

In a third illustrated setup (See FIGS. 10 and 12), a filtration module 102′ is positioned alongside the sidewall supporting the collapsible bag, preferably on the back side of the unit. See FIG. 10. The filtration module has an inlet for receipt of water from a building water system and at least one filter 104′ to filter the received water. See FIG. 12. An outlet conduit means 111 supplies the filtered water from the filtration module to the inside of the collapsible bag. A water supply line 113 carries water from the building water system to the filtration module. A coupling 115 connects the water supply line to the inlet of the filtration module. A valve 117 control the flow of water through the water supply line, and thereby the flow of filtered water into the bag. A means 110 senses when the liquid level in the collapsible bag has fallen to a predetermined lower limit and producing an output signal in response thereto to open the valve and cause flow of water through the filtration module and into the collapsible bag. The means also senses when the liquid level in the collapsible bag has risen to a predetermined upper limit and terminating the output signal to close the valve and stop flow of water into the collapsible bag. Preferably, the coupling 115 is a quick-connect coupling so that the filtration module can be quickly connected and disconnected from the water supply line. The quick-connect coupling is preferably provided in upper and lower halves, and the upper half is provided with a check valve to prevent leakage when the filtration module is removed for service. The outlet conduit means 111 preferably a conduit section 119 mounted to the lid to supply filtered water to the inside of the collapsible bag and a quick-connect coupling 121 to connect such conduit section to the filtration module.

To provide overflow protection, the nozzle-plate on the bag defines a flow path means 112 for liquid through the sidewall of the collapsible bag which opens into an inside of the collapsible bag near an upper portion of the collapsible bag which is above the predetermined upper water limit. The apparatus is provided with a housing supporting the chiller, a container for liquids positioned in the housing, a means for indicating when a liquid level in the container has exceed a predetermined limit, and a conduit 114 for conveying overflow liquid from the nozzle to the container.

As described elsewhere herein, the lowermost part of the unit is preferably a housing which supports the chiller and carries parts of the refrigeration means and container for overflow. To provide aesthetics and reduce unintentional exposure to electrical parts of the unit, a cover 116 is provided which at least partially laterally surrounds the housing, the chiller, and the sidewall supporting the collapsible bag. The cover can assume many types of configurations and can be varied by customer if desired. Because the refrigeration means preferably further comprises a condenser coil positioned on a back side of the housing, the cover preferably defines a passage 118 to permit air circulation over the condensing coil. The cover also preferably defines a passage 120 to permit access to the valve assembly unit which permits liquid to be withdrawn. The passage is further preferably positioned in a recess defined by the cover, and a trough 122 at a lower end of the recess to capture spillage from the dispensing of liquid from the valve assembly unit. The cover preferably further includes a lid 124 positioned on an upper end thereof when the device is to be used with a water bottle.

While certain preferred embodiments of the invention have been described herein, the invention is not to be construed as being so limited, except to the extent that such limitations are found in the claims.

1. Apparatus for cooling and dispensing water or other beverages comprising
a reservoir means for holding a liquid,
a refrigeration means for cooling the liquid in the reservoir means, and
a dispenser means for dispensing liquid from the reservoir means, wherein.
the reservoir means has an upper portion and a lower portion,
the refrigeration means includes a chiller operatively associated with the lower portion of the reservoir means, and
the dispenser means includes a flow path means for defining a liquid flow path from the lower portion of the reservoir means to an outside of the cooler and dispenser unit,
wherein the reservoir means includes
a collapsible bag for containing the liquid, and
a sidewall supporting the collapsible bag.

2. Apparatus as in claim 1 wherein
the sidewall supporting the collapsible bag is thermally insulated or is constructed of a thermally insulating material.

3. Apparatus as in claim 1 wherein
the sidewall supporting the collapsible bag is of one-piece construction.

4. Apparatus as in claim 1 wherein the chiller has a chiller surface which supports a lower portion of the collapsible bag and at least a portion of the chiller surface is sloped with respect to vertical.

5. Apparatus as in claim 4 wherein the chiller has an opposed pair of chiller surface portions which are sloped with respect to vertical and form a U-bend.

6. Apparatus as in claim 4 wherein the chiller surface which supports the lower portion of the bag is generally trough-shaped.

7. Apparatus as in claim 6 wherein the chiller has an insulated chiller surface opposite from the chiller surface supporting the bag.

8. Apparatus as in claim 7 wherein the insulated chiller surface is generally flat.

9. Apparatus as in claim 2 wherein an outer wall of the chiller is received in a lower portion of the sidewall supporting the insulated bag.

10. Apparatus as in claim 1 wherein the flow path means includes a fixture carried by the sidewall of the collapsible bag.

11. Apparatus as in claim 10 wherein the fixture includes a flexible nozzle-plate of greater rigidity than the sidewall on which it is carried, said nozzle-plate having an outwardly facing surface and at least one outwardly-directed nozzle carried on the outwardly facing surface, said nozzle-plate and said nozzle defining a flow path for liquid through the sidewall of the collapsible bag.

12. Apparatus as in claim 11 wherein the flow path means further includes a valve assembly unit attached to the nozzle and operable to selectively stop and start flow of liquid through said flow path.

13. Apparatus as in claim 12 wherein the valve assembly unit comprises a valve-plate having a front side and a back side and a faucet protruding from the front side, said faucet and valve plate defining a flow path for liquid through the valve assembly unit from a liquid inlet on the back side of the valve-plate to an outlet at an outlet end of the faucet, wherein the nozzle carried by nozzle-plate sealingly engages the liquid inlet on the back side of the valve-plate.

14. Apparatus as in claim 13 further comprising an insulating plate positioned between the valve plate and the nozzle plate.

15. Apparatus as in claim 13 wherein the outwardly facing surface of said nozzle-plate further defines a plurality of latch elements and the back side of the valve plate carries a matching plurality of latch elements engaged with the plurality of latch elements on the nozzle-plate so that the valve-plate is latched to the nozzle-plate.

16. Apparatus as in claim 15 wherein the sidewall supporting the collapsible bag has an upper end and a lower end, a front side and a back side, and a notch in the front side extending from the upper end which receives the valve-plate, so that the nozzle-plate can be latched to the valve-plate to form an assembly which can be slid into location in the notch.

17. Apparatus as in claim 10 wherein the collapsible bag is formed from a thermoplastic film and has a front side wall, a back side wall, a bottom wall, and a pair of pleated side walls, wherein the sidewall which carries the fixture through which liquid is withdrawn from the bag is the front side wall, and the bottom wall of the collapsible bag rests on the chiller.

18. Apparatus as in claim 13
wherein the nozzle-plate has a second outwardly-directed nozzle carried on the outwardly facing surface, said nozzle-plate and said second outwardly-directed nozzle defining a second flow path for liquid through the sidewall of the collapsible bag,
wherein the valve-plate has second faucet protruding from the front side, said second faucet and valve plate defining a flow path for liquid through the valve assembly unit from a second liquid inlet on the back side of the valve-plate to an outlet at an outlet end of the second faucet,
and means for defining a liquid flow path between the second outwardly-directed nozzle and the second liquid inlet on the back side of the valve-plate.

19. Apparatus as in claim 18 wherein
the means defining the liquid flow path between the second outwardly directed nozzle and the second liquid inlet comprises,
a heater,
a first conduit extending between the second outwardly directed nozzle and the heater, and
a second conduit extending between the heater and the second liquid inlet,
whereby heated liquid can be dispensed from the second faucet.

20. Apparatus as in claim 19 further comprising
a first quick-connect coupler forming a portion of the first conduit, and
a second quick-connect coupler forming a portion of the second conduit,
so that the flow path means between the second liquid inlet and the second outwardly directed nozzle can be quickly connected or disconnected.

21. Apparatus as in claim 19 wherein the heater is positioned beneath the chiller.

22. Apparatus for cooling and dispensing water or other beverages comprising
a reservoir means for holding a liquid,
a refrigeration means for cooling the liquid in the reservoir means, and
a dispenser means for dispensing liquid from the reservoir means, wherein.
the reservoir means has an upper portion and a lower portion,
the refrigeration means includes a chiller operatively associated with the lower portion of the reservoir means, and
the dispenser means includes a flow path means for defining a liquid flow path from the lower portion of the reservoir means to an outside of the cooler and dispenser unit,
wherein the chiller is configured to non-uniformly remove heat from the liquid in the reservoir means, thereby causing convection currents which prevent thermal stratification of the liquid in the reservoir means.

23. Apparatus as in 22 wherein
the chiller has a chiller surface facing the liquid in the reservoir means, at least a portion of which is sloped with respect to vertical.

24. Apparatus for cooling and dispensing water or other beverages comprising
a reservoir means for holding a liquid,
a refrigeration means for cooling the liquid in the reservoir means, and
a dispenser means for dispensing liquid from the reservoir means,
wherein
the reservoir means has an upper portion and a lower portion,
the refrigeration means includes a chiller operatively associated with the lower portion of the reservoir means, and
the dispenser means includes a flow path means for defining a liquid flow path from the lower portion of the reservoir means to an outside of the cooler and dispenser unit,
said apparatus further comprising a housing supporting the chiller, and
a container for liquids positioned in the housing for receiving downwardly falling droplets of condensate and leakage.

25. Apparatus as in claim 24 wherein said refrigeration means further comprises a compressor positioned in the housing beneath the container.

26. Apparatus as in claim 24 further comprising a means for indicating when a liquid level in the container has exceed a predetermined limit.

27. Apparatus as in 26 wherein the means for indicating comprises a sensor operatively associated with an inside of the container for sensing when a liquid level in the container has exceeded a predetermined limit and producing an output signal in response thereto and an alarm device operatively associated with the sensor for producing an alarm signal in response to the output signal from the sensor.

28. Apparatus as in claim 24 wherein the container is slidably received in the housing.

29. Apparatus as in claim 28 wherein the housing has a front side and a back side, wherein the container is slidably received in an opening in the front side of the housing, wherein the refrigeration means further comprises a condenser coil positioned on a back side of the housing.

30. Apparatus as in claim 29 wherein the condenser coil is generally panel-shaped and the back side of the housing further defines a generally panel-shaped recess for receiving the condenser coil, said condenser coil being positioned in said recess.

31. Apparatus for cooling and dispensing water or other beverages comprising
a reservoir means for holding a liquid,
a refrigeration means for cooling the liquid in the reservoir means, and
a dispenser means for dispensing liquid from the reservoir means, wherein.
the reservoir means has an upper portion and a lower portion,
the refrigeration means includes a chiller operatively associated with the lower portion of the reservoir means, and
the dispenser means includes a flow path means for defining a liquid flow path from the lower portion of the reservoir means to an outside of the cooler and dispenser unit,
wherein the reservoir means includes
a collapsible bag for containing the liquid, and
a sidewall supporting the collapsible bag,
said apparatus further comprising a lid positioned on the upper end of the sidewall supporting the collapsible bag.

32. Apparatus as in claim 31 wherein the lid has a central opening.

33. Apparatus as in claim 32 wherein the collapsible bag for containing the liquid has an open upper end which is rolled over an upper end of the sidewall supporting the collapsible bag and the lid sandwiches the upper end of the collapsible bag between the upper end of the sidewall and the lid.

34. Apparatus as in claim 33 further comprising a water bottle positioned upside down partially through the central opening of the lid to supply water to the inside of the collapsible bag.

35. Apparatus as in claim 33 further comprising
a filtration module positioned in covering relationship with the lid, said filtration module having an inlet for receipt of water from a building water system, at least one filter to filter the received water, and an outlet to supply filtered water through the central opening of the lid to the inside of the collapsible bag,
an inlet valve to control flow of water through the filtration module,
means for sensing when a liquid level in the collapsible bag has fallen to a predetermined lower limit and producing an output signal in response thereto to open the inlet valve and cause flow of water through the filtration module and into the collapsible bag, and sensing when the liquid level in the collapsible bag has risen to a predetermined upper limit and terminating the output signal to close the inlet valve and stop flow of water into the collapsible bag.

36. Apparatus as in claim 33 further comprising
a filtration module positioned alongside the sidewall supporting the collapsible bag, said filtration module having an inlet for receipt of water from a building water system and at least one filter to filter the received water,
an outlet conduit means to supply filtered water from the filtration module to the inside of the collapsible bag,
a water supply line to carry water from the building water system to the filtration module,
a coupling to connect the water supply line to the inlet of the filtration module,
a valve to control flow of water through the water supply line,
a means for sensing when a liquid level in the collapsible bag has fallen to a predetermined lower limit and producing an output signal in response thereto to open the valve and cause flow of water through the filtration module and into the collapsible bag, and sensing when the liquid level in the collapsible bag has risen to a predetermined upper limit and terminating the output signal to close the valve and stop flow of water into the collapsible bag.

37. Apparatus as in claim 36 wherein the coupling is a quick-connect coupling so that the filtration module can be quickly connected and disconnected from the water supply line.

38. Apparatus as in claim 37 wherein the outlet conduit means includes a conduit section mounted to the lid to supply filtered water to the inside of the collapsible bag and a quick-connect coupling to connect such conduit section to the filtration module.

39. Apparatus as in claim 35 wherein the means for sensing comprises a pressure switch positioned between the outside of the collapsible bag and the sidewall supporting the collapsible bag near a lower portion of the collapsible bag, said pressure switch beginning to transmit an electrical signal to actuate the valve when sensed pressure falls to a predetermined lower limit and ceasing to transmit the electrical signal when sensed pressure reaches a predetermined upper limit.

40. Apparatus as in claim 39 wherein the collapsible bag for containing the liquid has a sidewall which carries a fixture through which liquid is withdrawn from the bag, said fixture including a flexible nozzle-plate of greater rigidity than the sidewall on which it is carried, said nozzle-plate having an outwardly facing surface and at least one outwardly-directed nozzle carried on the outwardly facing surface, said nozzle-plate and said nozzle defining a flow path for liquid through the sidewall of the collapsible bag, said flow path opening into an inside of the collapsible bag near an upper portion of the collapsible bag above the predetermined upper water limit,
said apparatus further comprising a housing supporting the chiller, a container for liquids positioned in the housing, a means for indicating when a liquid level in the container has exceed a predetermined limit, and a conduit for conveying overflow liquid from the nozzle to the container.

41. Apparatus as in claim 31 further comprising a housing supporting the chiller, said refrigeration means further comprising a compressor positioned in the housing.

42. Apparatus as in claim 41 further comprising
a cover at least partially laterally surrounding the housing, the chiller, and the sidewall supporting the collapsible bag.

43. Apparatus as in claim 42 wherein the refrigeration means further comprises a condenser coil positioned on a back side of the housing and the cover defines a passage to permit air circulation over the condensing coil.

44. Apparatus as in claim 43 wherein
the flow path means includes a fixture carried by the sidewall of the collapsible bag and a valve assembly unit attached to the fixture and operable to selectively stop and start flow of liquid through said flow path, wherein the cover further defines a passage to permit access to the valve assembly unit.

45. Apparatus as in claim 44 wherein the passage to permit access to the valve assembly unit is further positioned in a recess defined by the cover, said cover further forming a trough at a lower end of the recess to capture spillage from the dispensing of liquid from the valve assembly unit.

46. Apparatus as in claim 44 wherein the cover further includes a lid positioned on an upper end thereof.
